(19) United States
(12) Patent Application Publication
(10) Pub. No.: US 2019/0256185 A1
(43) Pub. Date: Aug. 22, 2019

(54) METHOD FOR MANUFACTURING A CENTRAL WING BOX FROM PROFILE SECTIONS PRODUCED USING HIGH-PRESSURE, LOW-TEMPERATURE FORMING, AND A CENTRAL WING BOX OBTAINED FROM IMPLEMENTING THE METHOD

(71) Applicant: Airbus Operations SAS, Toulouse (FR)

(72) Inventor: Jago PRIDIE, NANTES (FR)

(21) Appl. No.: 16/279,351

(22) Filed: Feb. 19, 2019

(30) Foreign Application Priority Data
Feb. 22, 2018 (FR) 1851500

(51) Int. Cl. B64C 1/06; B29C 70/30; B29D 99/00; B64F 5/10

(52) U.S. Cl. CPC B64C 1/068; B64F 5/10; B29D 99/0014; B29C 70/30

(57) ABSTRACT

A method for manufacturing an aircraft central wing box from a plurality of U-shaped and C-shaped profile sections made of composite material and from an outer skin of fibrous reinforcements formed on the U-shaped and C-shaped profile sections. The C-shaped and U-shaped profile sections are obtained by a method involving a step of compressing resin-impregnated fibrous reinforcements at a pressure greater than or equal to 7 bar and at a temperature less than or equal to 90° C. This solution makes it possible to optimize the dimensional and geometric accuracy of the profile sections and the surface finish thereof.

### CROSS-REFERENCES TO RELATED APPLICATIONS

This application claims the benefit of the French patent application No. 1851500 filed on Feb. 26, 2018, the entire disclosures of which are incorporated herein by way of reference.

### FIELD OF THE INVENTION

The present application relates to a method for manufacturing a central wing box from profile sections produced by high-pressure, low-temperature forming and to a central wing box obtained from implementing the said method.

### BACKGROUND OF THE INVENTION

As illustrated in FIG. 1, the structure of an aircraft comprises a fuselage 10 and a wing structure 12 which are connected by a central wing box 14.

According to a first embodiment illustrated in FIG. 2, the central wing box 14 comprises an upper panel 16, a lower panel 18, a front spar 20 and a rear spar 22.

For the remainder of the description, an internal surface or face corresponds to a surface or face facing towards the inside of the central wing box 14. Conversely, an external surface or face corresponds to a surface or face facing towards the outside of the central wing box 14.

Each panel or spar 16 to 22 is reinforced and on its internal face comprises stiffeners 24.

According to the first embodiment, the upper and lower panels 16, 18 and the front and rear spars 20 and 22 are produced independently of one another from metallic elements made of aluminum alloy which are machined in such a way as to form the stiffeners 24. Next, the upper and lower panels 16, 18 and the front and rear spars 20, 22 are assembled one to the next using L-shaped brackets 26 to form the central wing box 14.

These assembly operations are lengthy and have a significant impact on the cost of the central wing box 14.

According to a second embodiment described in document EP2590856, the central wing box is made of composite material by laying fibrous reinforcements around a core or around a mold that has four faces and a cross section identical to that of the central wing box. To obtain the stiffeners, profile sections made of composite material of U-shaped cross section in the case of the faces of the mold and of C-shaped cross section at each edge corner of the mold are arranged all around the mold. Each U-shaped profile section comprise a web and two flanges approximatively perpendicular to the web. Each C-shaped profile section comprises an L-shaped central part and two flanges one on each side of the L-shaped central part.

The U-shaped and C-shaped profile sections are juxtaposed in such a way that the flanges of two adjacent profile sections are firmly against one another to form a stiffener and that the webs and the L-shaped central parts of the profile sections are pressed against the mold.

To achieve that, the mold comprises, for each stiffener, a groove in each of which two pressed-together flanges of two adjacent profile sections are positioned.

Next, fibrous reinforcements are laid, for example, by winding, over the webs and the L-shaped central parts of the U-shaped and C-shaped profile sections.

At the end of the placement of the fibrous reinforcements, the assembly made up of the profile sections and the fibrous reinforcements is polymerized.

According to this second embodiment, the geometry of the upper and lower panels 16, 18 and of the front and rear spars 20 and 22 is closely governed by how well the following are mastered:

the thickness of the flange or of the L-shaped central part of each profile section,

the geometry and the surface finish of the external face of the web or of the L-shaped central part of each profile section.

In addition, the mechanical properties of the central wing box are also connected to those of the U-shaped and C-shaped profile sections, which must not exhibit porosity.

Document EP2334486 proposes a method for the manufacture of a U-shaped profile section. According to that document, first of all, a preform is produced by layering plies of fibers on a mandrill that has a U-shaped cross section. Next, the preform is positioned between a mold and a counter-mold so that it can be impregnated with resin and polymerized at a high temperature. Finally, the preform is compacted under vacuum at a high temperature of the order of 100 to 150° C., in order to avoid defects at the corners of the profile section.

During this manufacturing method, numerous air bubbles become trapped between the fiber plies, making the profile section porous.

The present invention seeks to overcome the disadvantages of the prior art.

### SUMMARY OF THE INVENTION

To that end, one subject of the invention is a method for manufacturing an aircraft central wing box from a plurality of U-shaped and C-shaped profile sections made of composite material and from an outer skin of fibrous reinforcements formed on the U-shaped and C-shaped profile sections, the U-shaped profile sections each having a web and two flanges approximately perpendicular to the web, the C-shaped profile sections each having an L-shaped central part and two flanges one on each side of the L-shaped central part, the manufacturing method comprising the following steps:

placing the juxtaposed U-shaped and C-shaped profile sections all around a mold so that the flanges of two adjacent profile sections are firmly against one another to form a stiffener positioned in one of the grooves of the mold and so that the webs and the L-shaped central parts of the U-shaped and C-shaped profile sections are pressed against the mold,

placing the outer skin on external faces of the webs and of the L-shaped central parts of the U-shaped and C-shaped profile sections,

polymerizing, and

demolding.

According to the invention, the method for manufacturing the central wing box is characterized in that the C-shaped and U-shaped profile sections are obtained from a method involving a step of forming at a pressure greater than or equal to 7 bar and at a temperature less than or equal to 90° C.

This forming step, prior to curing, makes it possible to reduce the porosity, to control the thickness of the C-shaped and U-shaped profile sections and ultimately to improve the mechanical properties of the central wing box obtained.

According to another feature, the C-shaped and U-shaped profile sections are obtained by a pultrusion method involving a forming step comprising a substep of compressing resin-impregnated fibrous reinforcements at a pressure greater than or equal to 7 bar and at a temperature less than or equal to 90° C.

According to one procedure, the compression substep is performed at a pressure comprised between 12 and 15 bar and/or at a temperature of the order of 65° C.

According to another feature, the C-shaped and U-shaped profile sections are obtained from preimpregnated fibrous reinforcements.

Another subject of the invention is an aircraft central wing box obtained from the manufacturing method according to one of the preceding features.

### BRIEF DESCRIPTION OF THE DRAWINGS

Further features and advantages will become apparent from the description of the invention which will follow, which description is given purely by way of example with reference to the attached drawings among which:

FIG. 1 is part of an aircraft fuselage which comprises a central wing box,

FIG. 2 is a perspective view of a central wing box before it is assembled according to a first embodiment of the prior art,

FIG. 3 is a perspective view of a central wing box obtained according to one embodiment of the invention,

FIG. 4 is a cross section through a mold and through profile sections added to the mold, illustrating one embodiment of the invention,

FIG. 5 is a perspective view of a U-shaped profile section, illustrating one embodiment of the invention,

FIG. 6 is a perspective view of a C-shaped profile section, illustrating one embodiment of the invention, and

FIG. 7 is a diagram depicting various workstations of a device for manufacturing profile sections by pultrusion.

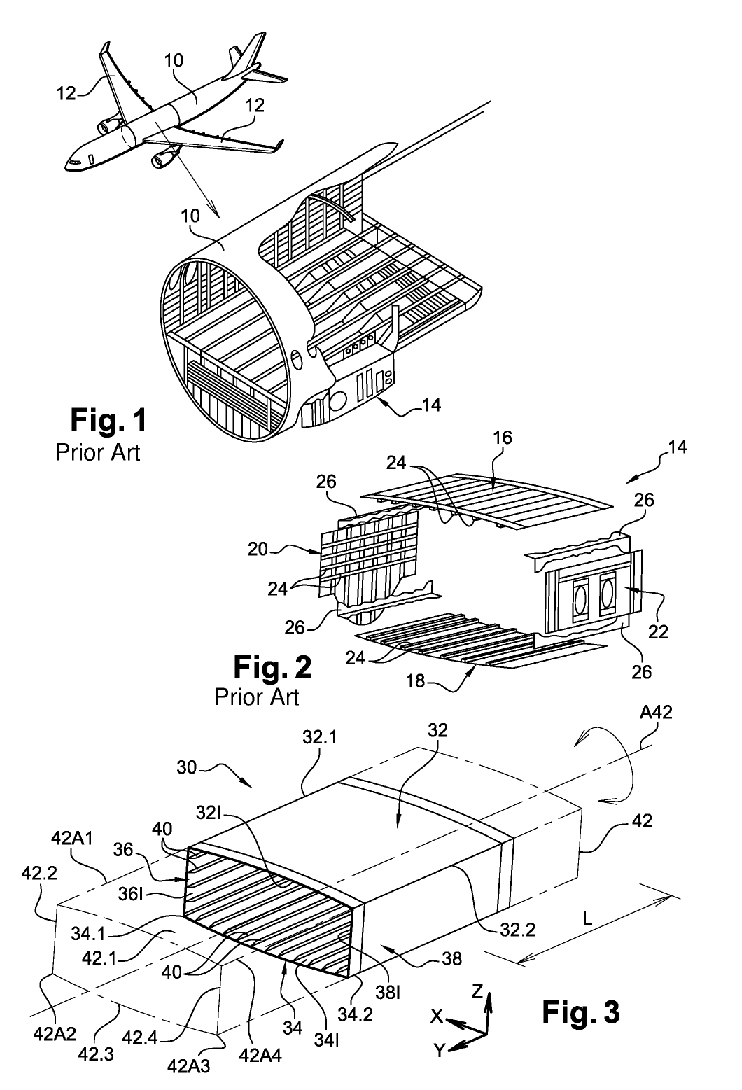

### DETAILED DESCRIPTION OF THE PREFERRED EMBODIMENTS

As illustrated in FIG. 3, a central wing box 30 comprises an upper panel 32, a lower panel 34, a front spar 36 and a rear spar 38.

The upper panel 32 has a front edge 32.1 and a rear edge 32.2 which are substantially parallel. The lower panel 34 has a front edge 34.1 and a rear edge 34.2 which are substantially parallel. The front edges 32.1 and 34.1 of the upper and lower panels 32, 34 are connected by the front spar 36, and the rear edges 32.2 and 34.2 of the upper and lower panels 32, 34 are connected by the rear spar 38.

The front and rear spars 36, 38 are substantially planar and parallel and are perpendicular to a longitudinal direction X. The front and rear edges 32.1, 34.1, 32.2, 34.2 of the upper and lower panels 32, 34 are parallel to a horizontal transverse direction Y. The vertical direction Z is perpendicular to the directions X and Y.

The length of an element corresponds to a dimension of the element measured parallel to the horizontal transverse direction Y.

The upper and lower panels 32, 34 and the front and rear spars 36, 38 all have substantially the same length L.

The upper and lower panels 32, 34 and the front and rear spars 36, 38 each have an internal face referenced 321, 341, 361 and 381 respectively.

The internal faces 321, 341, 361 and 381 of the upper and lower panels 32, 34 and of the front and rear spars 36, 38 comprise stiffeners 40 which are parallel to the horizontal transverse direction Y.

According to the invention, the central wing box 30 is made of composite material.

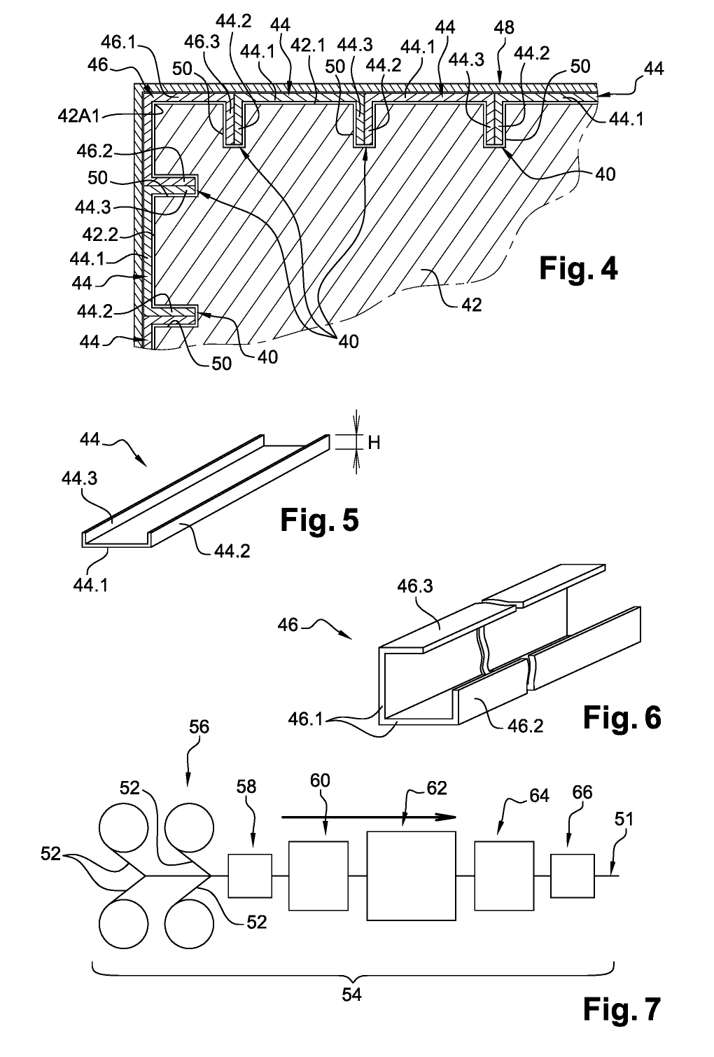

As illustrated in FIG. 4, the central wing box 30 is obtained from a plurality of profile sections 44, 46 made of composite material, on which an outer skin 48 is formed from fibrous reinforcements. The plurality of profile sections 44, 46 made of composite material are positioned around a mold 42 (visible in part in FIG. 3 in chain line, and in FIG. 4 in cross section).

What is meant by a fibrous reinforcement is at least one fiber, a collection of fibers, one or more fiber mini-plies or one or more plies.

The mold 42 comprises four faces 42.1 to 42.4 connected, one to the next, at four edge corners 42.A1 to 42.A4 and set out in the same way as the internal faces 321, 341, 361 and 381 of the upper and lower panels 32, 34 and of the front and rear spars 36, 38 of the central wing box 30. According to one configuration, the mold 42 has an axis of pivoting A42 parallel to the edge corners 42.A1 to 42.A4 and to the horizontal transverse direction Y so as to allow the winding of the fibrous reinforcements.

The mold 42 comprises grooves 50, parallel to the edge corners 42.A1 to 42.A4, formed on the faces 42.1 to 42.4 of the mold 42, one groove 50 for each stiffener 40.

The central wing box 30 is obtained from U-shaped profile sections 44 positioned parallel to the axis of pivoting A42 at the faces 42.1 to 42.4 of the mold 42 and of C-shaped profile sections 46 positioned parallel to the axis of pivoting A42 at each of the edge corners 42.A1 to 42.A4 of the mold 42.

As illustrated in FIG. 5, each U-shaped profile section 44 comprises a web 44.1 and two flanges 44.2 and 44.3 which are approximatively perpendicular to the web 44.1.

As illustrated in FIG. 6, each C-shaped profile section 46 comprises an L-shaped central part 46.1 and two flanges 46.2, 46.3, one on each side of the L-shaped central part 46.1.

To give an idea of an order of magnitude, each profile section has a thickness of the order of 4 to 6 mm and the flanges of the profile sections 44, 46 have a height of the order of 45 mm.

The U-shaped and C-shaped profile sections 44, 46 are juxtaposed all around the mold 42 so that the flanges of two adjacent profile sections are pressed one against the other to form a stiffener 40 positioned in one of the grooves 50 of the mold 42 and so that the internal faces of the webs 44.1 and of the L-shaped central parts 46.1 are pressed against the mold 42.

After the U-shaped and C-shaped profile sections 44, 46 have been placed on the mold 42, the outer skin 48 is applied to the external faces of the webs 44.1 and of the L-shaped central parts 46.1. According to one procedure, the outer skin 48 is obtained by winding fibrous reinforcements around the mold 42 (which pivots about the axis of pivoting A42) using at least one laying head that lays fibers or fiber tows.

After the placement of the outer skin 48, drainage systems and a fluid-tight wrapper also known as a bag are installed over the outer skin 48, the fluid-tight wrapper being connected in a fluid-tight manner to the mold 42 on each side of the outer skin 48.

Advantageously, the mold 42 is fluid tight and has a length longer than that of the central wing box 30 and extends beyond the latter at each end so as to offer the bag a contact surface on each end.

According to a first alternative form, the outer skin 48 is made from preimpregnated fibrous elements.

According to a second alternative form, the outer skin 48 is made from dry fibrous elements. In that case, a resin is injected or infused into the chamber delimited by the fluid-tight mold 42 and the bag.

The assembly formed by the mold 42, the U-shaped and C-shaped profile sections 44, 46, the outer skin 48, the drainage systems and the bag are placed in an autoclave at 7 bar and subjected to a polymerization cycle to consolidate the central wing box 30 by polymerizing the outer skin 48.

According to an alternative form, the cohesion between the outer skin 48 and the webs 44.1 and the central parts 46.1 of the C-shaped and U-shaped profile sections 44, 46 may be obtained by bonding, by co-curing or by any other means.

The central wing box thus formed is then demolded.

The steps of placing the C-shaped and U-shaped profile sections 44, 46 on the mold 42, of placing the fibrous reinforcements to form the outer skin 48 on the webs 44.1 and the central parts 46.1 of the C-shaped and U-shaped profile sections 44, 46, of placing the drainage systems and fluid-tight wrapper are not described further because they are known to those skilled in the art.

The C-shaped and U-shaped profile sections 44, 46 are obtained by a pultrusion method.

In order to produce a profile section 51 that has a desired cross section, the pultrusion manufacturing method comprises a forming step which involves:

a step of continuously shaping and impregnating with resin dry fibrous reinforcements 52 which are arranged in a geometry according to the desired cross section,

a step of compressing the resin impregnated fibrous reinforcements 52 in order to reduce the porosity, and

a step of curing in order to obtain the profile section 51 continuously.

According to one embodiment visible in FIG. 7, a pultrusion device 54 comprises a feed station 56 at which fibrous reinforcements 52 are fed in, a shaping and impregnation station 58 configured to arrange the fibrous reinforcements 52 in a geometry of the desired cross section and impregnates them with resin, a compression station 60 configured to compress the resin-impregnated fibrous reinforcements 52, a curing station 62 configured to cure the impregnated and compressed fibrous reinforcements 52, a traction station 64 configured to continuously pull the fibrous reinforcements 52 and a cutting station 66 configured to cut the profile section obtained at the exit of the curing station 62 to the desired length.

According to another embodiment, the fibrous reinforcements 52 are preimpregnated. In that case, the pultrusion method does not include the step of impregnating with resin and the pultrusion device comprises no impregnation station.

According to one particular feature of the invention, the compression step is performed at a high pressure greater than or equal to 7 bar and at a low temperature less than or equal to 90° C. The pressure and temperature values are adjusted according to the material. For example, when the fibrous reinforcements 52 used are fibrous reinforcements marketed under the reference TORAY® 3911, the step of compressing the fibrous reinforcements may be performed at a pressure comprised between 12 and 15 bar and at a temperature less than or equal to 90° C.

Advantageously, the compression step is performed at a temperature of the order of 65° C.

This solution makes it possible to reduce the porosity prior to curing step and to control the thickness of the C-shaped and U-shaped profile sections 44, 46.

At the end of the pultrusion method, the U-shaped and C-shaped profile sections may be fully polymerized or partially polymerized. In the latter instance, the curing step needs to be sufficient to ensure the dimensional and geometric stability of the U-shaped and C-shaped profile sections.

The fact that the U-shaped and C-shaped profile sections 44, 46 are produced by pultrusion allows perfect control over:

the thickness of the webs 44.1 and of the L-shaped central parts 46.1 of the U-shaped and C-shaped profile sections 44, 46,

the geometry and surface finish of the external faces thereof,

all this contributing to mastering the geometry of the upper and lower panels 32, 34 and of the front and rear spars 36, 38.

In addition, the fact that the porosity of the U-shaped and C-shaped profile sections 44, 46 has been reduced, contributes to improving the mechanical properties of the central wing box obtained.

According to an alternative form of the invention, polymerization on the mold 42 may be performed in an oven at ambient temperature.

According to another alternative form of the invention, the U-shaped and C-shaped profile sections 44, 46 may be produced according to the manufacturing method described in document EP2334486 and comprising a forming step involving a substep of compressing the fibrous reinforcements, the said compression substep being performed at a temperature less than 90° C. and at a pressure greater than or equal to 7 bar, preferably of between 7 and 15 bar.

According to an alternative form of the invention, the U-shaped and C-shaped profile sections 44, 46 may be formed using what is known as a diaphragm forming method known to those skilled in the art, said method comprising a forming step during which the U-shaped and C-shaped profile sections 44, 46 are formed on a diaphragm in an autoclave, the said forming step involving a substep of compressing the fibrous reinforcements and being performed in an autoclave the temperature of which is maintained at a temperature less than or equal to 90° C. and the pressure of which is maintained greater than or equal to 7 bar, preferably between 7 and 15 bar.

According to one embodiment the mold and/or the diaphragm are perforated allowing the air to escape.

According to one embodiment, the application of the pressure in the autoclave is delayed to delay the pressure onset and to gradually increase the pressure from 7 to 9 bars.

While at least one exemplary embodiment of the present invention(s) is disclosed herein, it should be understood that modifications, substitutions and alternatives may be apparent to one of ordinary skill in the art and can be made without departing from the scope of this disclosure. This disclosure is intended to cover any adaptations or variations of the exemplary embodiment(s). In addition, in this disclosure, the terms “comprise” or “comprising” do not exclude other elements or steps, the terms “a” or “one” do not exclude a plural number, and the term “or” means either or both. Furthermore, characteristics or steps which have been described may also be used in combination with other characteristics or steps and in any order unless the disclosure or context suggests otherwise. This disclosure hereby incorporates by reference the complete disclosure of any patent or application from which it claims benefit or priority.

1. A method for manufacturing an aircraft central wing box from a plurality of U-shaped and C-shaped profile sections made of composite material and from an outer skin of fibrous reinforcements formed on the U-shaped and C-shaped profile sections, the U-shaped profile sections each having a web and two flanges approximately perpendicular to the web, the C-shaped profile sections each having an L-shaped central part and two flanges one on each side of the L-shaped central part, the manufacturing method comprising the following steps:
forming the C-shaped and U-shaped profile sections at a pressure greater than or equal to 7 bar and at a temperature less than or equal to 90° C.,
placing juxtaposed U-shaped and C-shaped profile sections all around a mold so that the flanges of two adjacent profile sections are firmly against one another to form a stiffener positioned in a groove of the mold and so that the webs and the L-shaped central parts of the U-shaped and C-shaped profile sections are pressed against the mold,
placing an outer skin of the wing box on external faces of the webs and of the L-shaped central parts of the U-shaped and C-shaped profile sections,
polymerizing the U-shaped and C-shaped profile sections and outer skin, and
demolding the U-shaped and C-shaped profile sections and outer skin.

2. The method for manufacturing an aircraft central wing box according to claim 1, wherein the C-shaped and U-shaped profile sections formed by a pultrusion method involving a forming step comprising a substep of compressing resin-impregnated fibrous reinforcements at a pressure greater than or equal to 7 bar and at a temperature less than or equal to 90° C.

3. The method for manufacturing an aircraft central wing box according to claim 2, wherein the compressing substep is performed at a pressure comprised between 12 and 15 bar.

4. The method for manufacturing an aircraft central wing box according to claim 2, wherein the compressing substep is performed at a temperature of approximately 65° C.

5. The method for manufacturing an aircraft central wing box according to claim 1, wherein the C-shaped and U-shaped profile sections are obtained from preimpregnated fibrous reinforcements.

6. An aircraft central wing box obtained from the manufacturing method according to claim 1.
